(19) United States
(12) Patent Application Publication
(10) Pub. No.: US 2018/0113022 A1
(43) Pub. Date: Apr. 26, 2018

(54) INTEGRATED CIRCUIT FOR SENSOR APPLICATIONS

(71) Applicant: OSRAM Opto Semiconductors GmbH, Regensburg (DE)

(72) Inventors: Tim Boescke, Regensburg (DE); Christoph Goeltner, Cupertino, CA (US)

(21) Appl. No.: 15/298,370

(22) Filed: Oct. 20, 2016

(51) Int. Cl. G01J 1/44; G01J 1/02; G01J 1/08

(52) U.S. Cl. CPC G01J 1/44; G01J 1/08; G01J 1/0271; G01J 1/0204

(57) ABSTRACT

An integrated circuit for sensor applications includes a plurality of photosensitive areas on a top side, capable of measuring incident light, thereby creating a signal, and a processing unit adapted to evaluate the signal measured by the photosensitive areas; and a sensor including 1) the integrated circuit, 2) a housing with a first cavity and a second cavity, and 3) a barrier located between the first cavity and the second cavity, wherein the integrated circuit is located within the first cavity, the top side of the integrated circuit faced upwardly, and a light source is located within the second cavity.

### TECHNICAL FIELD

This disclosure relates to an integrated circuit for sensor applications.

### BACKGROUND

Optoelectronic sensors can be realized as an optoelectrical component with a light source, a photosensitive detector and a control circuit. Light emitted from the light source hits a sample intended for examination. Light reflected and/or scattered from the sample can be detected with the photosensitive detector and evaluated for signals due to processes within the sample. To decrease the size of the optoelectronic sensor, the photosensitive detector and the control circuit may be implemented within an application-specific integrated circuit. An optoelectronic sensor like this may be used as a biosensor.

It could therefore be helpful to provide an improved integrated circuit, an optoelectronic sensor with such an integrated circuit and a method of operation of such a sensor.

### SUMMARY

We provide an integrated circuit for sensor applications including a plurality of photosensitive areas on a top side, capable of measuring incident light, thereby creating a signal; and a processing unit adapted to evaluate the signal measured by the photosensitive areas.

We also provide a sensor including 1) the integrated circuit for sensor applications including a plurality of photosensitive areas on a top side, capable of measuring incident light, thereby creating a signal, and a processing unit adapted to evaluate the signal measured by the photosensitive areas, 2) a housing with a first cavity and a second cavity, and 3) a barrier located between the first cavity and the second cavity, wherein the integrated circuit is located within the first cavity, the top side of the integrated circuit faces upwardly, and a light source is located within the second cavity.

We further provide a method of operating a sensor, wherein the sensor includes a light source and an integrated circuit with photosensitive areas, and the integrated circuit includes a control circuit to control the light source, including operating the light source with a periodical increase and decrease of the power of the emitted light, exhibiting an operating frequency, and filtering the signal measured by the photosensitive areas of the integrated circuit using the operating frequency.

We also further provide a method of operating a sensor including obtaining an AC portion and a DC portion of a signal measured by photosensitive areas of an integrated circuit of the sensor, and ignoring the signal measured by one of the photosensitive areas if the AC portion of the photosensitive area compared to the DC portion decreases below a pre-set value.

### BRIEF DESCRIPTION OF THE DRAWINGS

FIG. 1 shows a schematic illustration of a top view of an integrated circuit with two photosensitive areas.

FIG. 2 shows a schematic illustration of a top view of an integrated circuit with four photosensitive areas.

FIG. 3 shows a schematic illustration of a top view of an integrated circuit with five photosensitive areas.

FIG. 4 shows a schematic illustration of a cross section of a sensor with a light source and an integrated circuit.

FIG. 5 shows a schematic illustration of a cross section of a sensor with two light sources and an integrated circuit.

### REFERENCE NUMERALS

100 integrated circuit
101 housing
102 top side
110 photosensitive area
120 processing unit
130 interconnection and component area
150 control circuit
160 reflective area
200 sensor
210 housing
211 first cavity
212 second cavity
213 third cavity
214 barrier
215 top side
216 reflective area
220 light source
221 another light source

### DETAILED DESCRIPTION

An integrated circuit comprises a plurality of photosensitive areas on a top side of the integrated circuit, capable of measuring incident light, thus creating a signal and a processing unit capable of evaluating the signal measured by the photosensitive areas. Integrating photosensitive areas into an integrated circuit generally leads to smaller active areas of the photosensitive areas compared to the approach of a sensor with an external photosensitive detector. The smaller active areas may be covered with a disturbing element during measurements, for instance by a human hair during a measurement of blood chemistry or heart rate when used as a biosensor or by dust particles during a measurement of environmental data. With the use of a plurality of photosensitive areas on top of the integrated circuit, a signal is still obtainable even if a photosensitive area is covered by a disturbing element.

The processing unit of the integrated circuit may be capable of evaluating the signal of every photosensitive area individually. Thus, the signal quality can be increased, as it is possible to detect if a photosensitive area is covered and thus not working properly. The signal of the photosensitive area not working properly can be neglected, increasing the signal quality.

A control circuit for an external light source may also be part of the integrated circuit. Thus, the external light source can be controlled with the integrated circuit, simplifying the design of the sensor using the integrated circuit as a component.

The top side may comprise a reflective area outside the photosensitive areas. Therefore, stray light not hitting the photosensitive areas may be reflected from the reflective area and after that by other areas of the sensor, increasing the chance that the reflected light finally hits the photosensitive areas of the integrated circuit.

The integrated circuit may be rectangular and two photosensitive areas are located at opposite corners of the integrated circuit. Therefore, the photosensitive areas are not easily covered by a single disturbing element, allowing for a measurement even if one single photosensitive area is covered by the disturbing element.

In the rectangular integrated circuit, four photosensitive areas may be located at four corners of the integrated circuit. This further decreases the probability that all photosensitive areas are covered by a disturbing element each, thus further increasing the signal quality of the sensor using such an integrated circuit.

A fifth photosensitive area may be located at a middle portion of the integrated circuit. This further decreases the probability of a disturbing element covering all photosensitive areas of the integrated circuit.

The area of a photosensitive area may be 0.16 square millimeters or less and the area of the integrated circuit is 1 square millimeter or less. With these sizes, integrated circuits with a small package size are possible, allowing for small sizes of the corresponding sensor.

A sensor comprises an integrated circuit, a housing with a first cavity and a second cavity and a light source. A barrier is located between the first cavity and the second cavity. The integrated circuit is located within the first cavity of the housing, wherein the top side of the integrated circuit faces upward. The light source is located within the second cavity of the housing. Due to the barrier between the cavities, light emitted from the light source does not reach the photosensitive areas of the integrated circuit directly. A sample set on top of the housing covering the cavities leads to scattering of the light emitted from the light source dependent on activity within the sample. For instance, a tissue may be the sample. The amount of light scattered towards the photosensitive areas may change periodically due to a change in an amount of blood within the tissue due to the blood circulation. The frequency of the change corresponds to a heart rate of the blood circulation.

The integrated circuit may particularly be capable of evaluating the signals of the photosensitive areas individually, comprise a control circuit for the external light source, comprise a reflective area at the top side, be of one of the previously described shapes or sizes or exhibit a combination of the aforementioned attributes.

The sensor housing may comprise a third cavity with another light source located within the third cavity. Therefore, processes detectable with light of different wavelengths can be detected.

The first cavity may comprise a reflective surface outside a location of the integrated circuit. This is particularly useful if the integrated circuit comprises a reflective area as well and enhances the probability of light scattered by the tissue to reach the photosensitive areas.

In a method of operating a sensor with a light source and an integrated circuit with photosensitive areas, in which the integrated circuit comprises a control circuit to control the light source, the light source is operated with a periodical increase and decrease of the power of the emitted light. Therefore, the light source exhibits an operating frequency. The signal measured by the photosensitive areas of the integrated circuit is filtered using the operating frequency as filtering frequency. With this approach, the operating frequency is used to pre-set a bandpass filter, thus increasing the signal quality.

In a method of operating a sensor, an AC portion and a DC portion of a signal measured by photosensitive areas of an integrated circuit of the sensor is obtained. The signal measured by one of the photosensitive areas is neglected if the AC portion of the photosensitive area compared to the DC portion decreases below a pre-set value. Therefore, the signal of a photosensitive area irradiated with ambient light not intended for the measurement, which is overpowering compared to the light used for measuring and thus leading to a large DC portion of the signal obtained, may be neglected to increase the signal quality.

In the method of operation, a signal indicating a measurement failure due to the large DC portion compared to the AC portion may be displayed to indicate the immission of stray ambient light.

The above described properties, features and advantages as well as the method of obtaining them, will be more clearly understandable in the context of the following description of the examples, which are explained in more detail in the context of the figures.

FIG. 1 shows a top view of an integrated circuit 100 with two photosensitive areas 110 and a processing unit 120. The integrated circuit 100 comprises a housing 101. The housing 101 is of rectangular shape. The two photosensitive areas 110 are located on a top side 102 of the housing 101. An interconnection and component area 130 is located within the housing 101 of the integrated circuit, providing space for the processing unit 120 and electrical wiring (not shown in FIG. 1) of the photosensitive areas 110 and the processing unit 120. The photosensitive areas 110 are located outside of the interconnection and component area 130. The photosensitive areas 110 are capable of measuring incident light, thus creating a measurement signal proportion-al to the power of the incident light. The processing unit 120 is capable of evaluating the signal measured by the photosensitive areas 110. The photosensitive areas 110 are arranged in opposite corners of the rectangular housing 101 and thus in opposite corners of the integrated circuit 100.

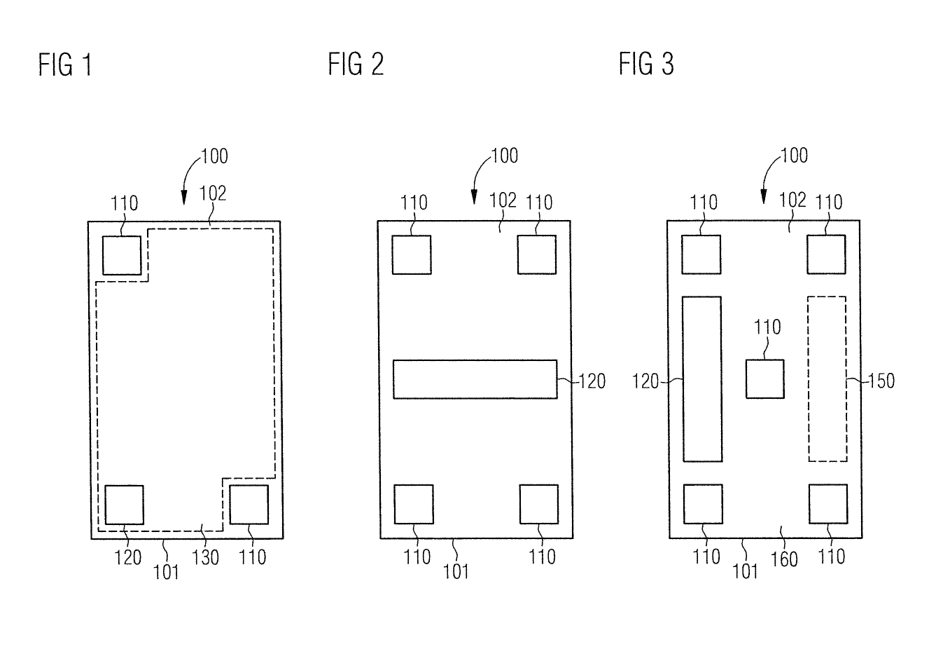

FIG. 2 shows another top view of an integrated circuit 100 similar to the integrated circuit of FIG. 1. The integrated circuit 100 comprises four photosensitive areas 110, arranged in the four corners of the rectangular housing 101. The processing unit 120 is located within a rectangle formed by the four photosensitive areas 110.

FIG. 3 shows a top view of another example of the integrated circuit 100 similar to FIG. 2. A fifth photosensitive area 110 is located within a middle portion of the integrated circuit 100. The arrangement of the photosensitive areas 110 thusly resembles the arrangement of the eyes of a die showing a five-face. The processing unit 120 is arranged adjacent to the photosensitive area 110 located at the middle portion of the integrated circuit 100.

A reflective area 160 is located at the top side 102. The reflective area 160 is located outside the photosensitive areas 110. Incident light not reaching the photosensitive areas 110 then may be reflected by the top side 102 of the housing 101. If the integrated circuit 100 is placed within a sensor, which also comprises reflective surfaces, the reflected light may reach the photosensitive areas 110 after several reflections at the reflective surfaces. A reflective area 160 may also be arranged on the top side 102 of the integrated circuits 100 of FIGS. 1 and 2.

The shape of the housing 101 of FIGS. 1 to 3 may be varied, for instance to a circular or hexagonal shape. Furthermore, the number of photosensitive areas 110 and the arrangement of the photosensitive areas 110 may be varied.

In one example the processing unit 120 is capable of evaluating the signal of every photosensitive area 110 individually. If a photosensitive area 110 is covered by a disturbing element, for instance a human hair during a biosensing operation, the signal of the covered photosensitive area may be neglected, increasing the overall signal quality.

In one example, the integrated circuit 100 comprises a control unit 150 indicated with a dashed line in FIG. 3. The control unit 150 may also be added to the examples of FIG. 1 or 2. The control unit is capable of controlling an external light source outside the integrated circuit. Therefore, the integrated circuit may comprise connectors to connect the external light source.

The area of the photosensitive areas 110 may be 0.16 square millimeters or less. The area of the photosensitive areas 110 may be, for instance, as small as 0.01 square millimeters. The area of the integrated circuit 100 is 1 square millimeter or less. With these sizes, a plurality of photosensitive areas 110 can be implemented within the integrated circuit 100. Furthermore, the remaining area of the integrated circuit 100 is sufficient for the processing unit 120, the optional control circuit 150 and the interconnections needed to electrically connect the photosensitive areas 110, the processing unit 120 and the optional control circuit 150.

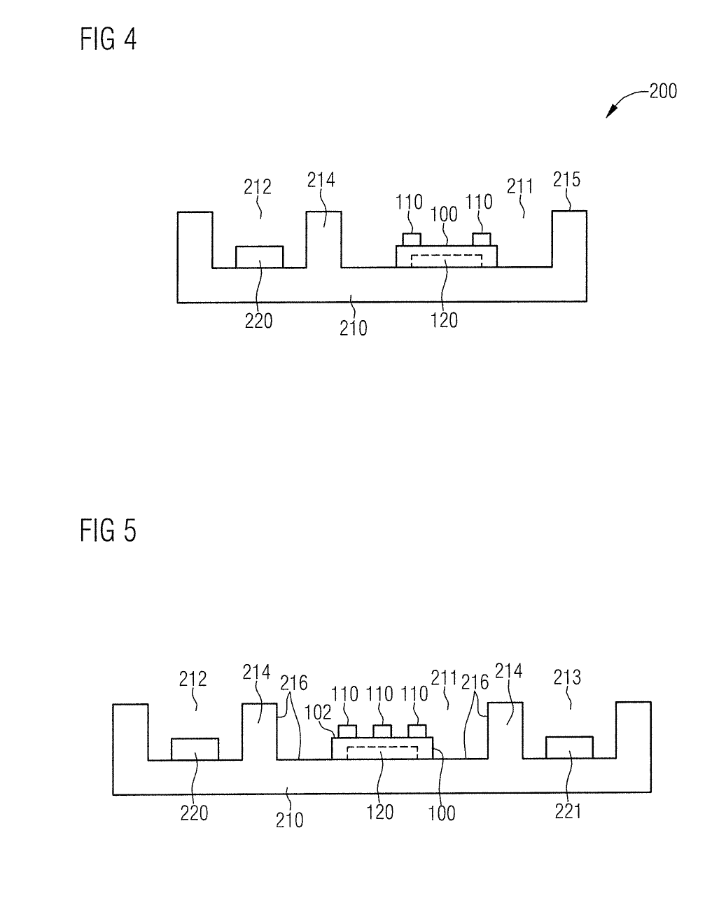

FIG. 4 shows a cross section of a sensor 200 with an integrated circuit 100 as shown in FIGS. 1 to 3. The sensor 200 comprises a housing 210. The housing 210 is of cuboid shape and comprises a first cavity 211 and a second cavity 212. The cavities 211, 212 are separated by a barrier 214. The housing 210 may exhibit a different shape.

A top side 215 of the housing, from which the cavities 211, 212 formed, may be placed on a sample intended to measure a signal. The first cavity 211 comprises the integrated circuit 110 described in FIGS. 1 to 3. The integrated circuit comprises photosensitive areas 110 and a processing unit 120. Note that the processing unit 120 is drawn with a dashed line indicating that the processing unit 120 is not within the plane of projection of the cross section shown in FIG. 4. Within the second cavity 212, a light source 220 is located. Light emitted from the light source 220 is scattered within sample placed on top of the top side 215 in a way that part of the scattered light reaches the photosensitive areas 110 of the integrated circuit 100. A wavelength of the light emitted from the light source 220 may be adapted to the signal expected. To be used as a heart-rate sensor, the light source 220 may emit light with a wavelength of 570 nanometers. If the integrated circuit 100 comprises a control circuit 150 to control an external light source, the light source 220 may also be controlled with the integrated circuit 100.

FIG. 5 shows a cross section of another example of a sensor 200. Additionally to the features of the sensor 200 of FIG. 4, the housing 210 comprises a third cavity 213 with another light source 221. The third cavity 213 is located next to the first cavity 211 on the opposite side of the second cavity 212 and separated from the first cavity 211 with another barrier 214. The other light source 221 may have the same wavelength or a different wavelength compared to the light source 220 within the second cavity 212. If the wavelengths of the light sources 220, 221 are similar, the other light source 221 may work as a backup for the light source 220. If the wavelengths of the light source 220 and the other light source 221 are different, different processes may be measured.

Within the first cavity 211, the sensor 200 comprises a reflective surface 216. This may be used additionally to a reflective area on the top side 102 of the integrated circuit 100. Incident light not reaching the photosensitive areas 110 may then be reflected at the reflective surfaces 216 and/or the top side 102, including multiple reflections, and finally reach the photosensitive areas 110 of the integrated circuit 100. It is possible to arrange reflective surfaces 216 in the first cavity 211 of FIG. 4 as well. On the other hand, the sensor with three cavities 211, 212, 213 and two light sources 220, 221 may be implemented without the reflective surface 216.

The light sources 220, 221 may be light emitting diodes or diode lasers.

For a blood oxygen and heart rate sensor as sensor 200, the light source 220 may emit green light with a wavelength of around 570 nanometers and the other light source 221 may emit red light with a wavelength of around 660 nanometers. With a wavelength of 570 nanometers, within an absorption band of hemoglobin, a heart rate can be obtained by evaluating the strayed light of a wavelength of 570 nanometers, as the intensity of the strayed light increases when less hemoglobin molecules and thus less blood is available within the sample measured. The signal at 570 nanometers thus increases and decreases proportionally to the heart rate. At 660 nanometers, absorption of hemoglobin is dependent on the oxygen content of the blood. Thus, this wavelength is suitable for blood oxygen measurements.

In a method of operating a sensor 200 with a light source 220 and an integrated circuit 100 with photosensitive areas 110, in which the integrated circuit 100 comprises a control circuit 150 to control the light source 220, the light source 220 is operated with a periodical increase and decrease of the power of the emitted light. Therefore, the light source 220 exhibits an operating frequency. The signal measured by the photosensitive areas 110 of the integrated circuit 100 is filtered using the operating frequency as filtering frequency. With this approach, the operating frequency is used to pre-set a bandpass filter, thus increasing the signal quality.

If the sensor 200 comprises another light source 221, as shown in FIG. 5, the light sources 220, 221 may be operated with different operating frequencies. With this approach, the signal obtained by the photosensitive areas 110 may be split and filtered for both operating frequencies, thus separating the portion of the signal obtained due to the light source 220 and due to the other light source 221.

If a blood oxygen content and a heart rate are to be measured with a sensor 200 with a light source with a wavelength of 570 nanometers and another light source 221 with a wavelength of 660 nanometers, the light source 220 may be operated with a first operating frequency of for instance 300 Hertz. The other light source may be operated with a second operating frequency of for instance 500 Hertz. The first operating frequency and the second operating frequency need to differ, and should not be factors of each other. Furthermore, the operating frequencies should differ from the expected heart rate, which is in the range of below 1 to 3 Hertz. The signal obtained by the photosensitive areas 110 is split and filtered with two bandpass filters of the first operating frequency of 300 Hertz and the second operating frequency of 500 Hertz to separate the signal of the heart rate obtained with the light emitted from the light source 220 and the signal of the blood oxygen content obtained with the light emitted from the other light source 221.

In a method of operating a sensor 200 an AC portion and a DC portion of a signal measured by photosensitive areas 110 of an integrated circuit 100 of the sensor 200 is obtained and wherein the signal measured by one of the photosensitive areas 110 is neglected if the AC portion of the photosensitive area 110 compared to the DC portion decreases below a pre-set value. Therefore, the signal of a photosensitive area 110 irradiated with ambient light not intended for the measurement, which is overpowering compared to the light used for the measuring and thus leading to a large DC portion of the signal obtained, may be neglected to increase the signal quality.

In one example of the method of operation, a signal indicating a measurement failure due to the large DC portion compared to the AC portion is displayed to indicate the immission of stray ambient light.

Although our integrated circuit was described and illustrated in more detail using preferred examples, this disclosure is not limited to the examples. Examples may be derived by those skilled in the art from the described examples without departing from the scope of the appended claims.

1. An integrated circuit for sensor applications comprising:
a plurality of photosensitive areas on a top side, capable of measuring incident light, thereby creating a signal; and
a processing unit adapted to evaluate the signal measured by the photosensitive areas.

2. The integrated circuit according to claim 1, wherein the processing unit evaluates the signal of every photosensitive area individually.

3. The integrated circuit according to claim 1, further comprising a control circuit for an external light source.

4. The integrated circuit according to claim 1, wherein the top side comprises a reflective area outside the photosensitive areas.

5. The integrated circuit according to claim 1, wherein the integrated circuit is rectangular and two photosensitive areas are located at opposite corners of the integrated circuit.

6. The integrated circuit according to claim 5, wherein four photosensitive areas are located at four corners of the integrated circuit.

7. The integrated circuit according to claim 6, wherein a fifth photosensitive area is located at a middle portion of the integrated circuit.

8. The integrated circuit according to claim 1, wherein the area of a photosensitive area is 0.16 square millimeters or less and wherein the area of the integrated circuit is 1 square millimeter or less.

9. A sensor comprising:
1) the integrated circuit according to claim 1;
2) a housing with a first cavity and a second cavity, and
3) a barrier located between the first cavity and the second cavity,
wherein the integrated circuit is located within the first cavity, the top side of the integrated circuit faces upwardly, and
a light source located within the second cavity.

10. The sensor according to claim 9, wherein the housing comprises a third cavity, and another light source is located within the third cavity.

11. The sensor according to claim 9, wherein the first cavity comprises a reflective surface outside a location of the integrated circuit.

12. The sensor according to claim 10, wherein the first cavity comprises a reflective surface outside a location of the integrated circuit.

13. A method of operating a sensor, wherein the sensor comprises a light source and an integrated circuit with photosensitive areas, and the integrated circuit comprises a control circuit to control the light source, comprising operating the light source with a periodical increase and decrease of the power of the emitted light, exhibiting an operating frequency, and filtering the signal measured by the photosensitive areas of the integrated circuit using the operating frequency.

14. A method of operating a sensor comprising:
obtaining an AC portion and a DC portion of a signal measured by photosensitive areas of an integrated circuit of the sensor is obtained; and
ignoring the signal measured by one of the photosensitive areas if the AC portion of the photosensitive area compared to the DC portion decreases below a pre-set value.
